(19) United States
(12) Patent Application Publication
(10) Pub. No.: US 2022/0221709 A1
(43) Pub. Date: Jul. 14, 2022

(54) Mirror Device for an Interferometer Device, Interferometer Device and Method for Producing a Mirror Device

(71) Applicant: Robert Bosch GmbH, Stuttgart (DE)

(72) Inventors: Christoph Schelling, Stuttgart (DE); Christoph Daniel Kraemmer, Malsch (DE); Reinhold Roedel, Reutlingen (DE)

(21) Appl. No.: 17/609,578

(22) PCT Filed: Apr. 29, 2020
(86) PCT No.: PCT/EP2020/061876

§ 371 Date: Nov. 8, 2021

(30) Foreign Application Priority Data
May 10, 2019 (DE) 10 2019 206 758.1

(51) Int. Cl. G02B 26/00; G02B 5/08; G02B 5/28; G01J 3/26

(52) U.S. Cl. CPC G02B 26/001; G02B 5/0816; G01J 2003/1247; G01J 3/26; G02B 5/284

(57) ABSTRACT

The disclosure relates to a mirror device for an interferometer device including a first mirror layer and a second mirror layer, which are arranged in parallel on top of one another and spaced apart from one another by a mirror layer spacing. The mirror layer spacing forms an intermediate space between the first and the second mirror layer. The intermediate space includes a gas or a vacuum, and at least one spacing structure which extends at least partially between the first and the second mirror layer. The spacing structure has a material that is the same as or different from the first and/or second mirror layer.

The present invention relates to a mirror device for an interferometer device, to an interferometer device, and to a method for producing a mirror device.

### PRIOR ART

For spectral filters that are variable (tunable) over a plurality of wavelengths and are transmissive for only specific wavelengths, it is possible to realize miniaturization, for example with Fabry-Perot interferometers (FPI), for example by means of a micro-electromechanical design (MEMS technology). A cavity having two highly reflective mirrors, which are substantially plane-parallel and have a spacing (cavity length) in the order of optical wavelengths, may exhibit strong transmission only for those wavelengths that correspond, in terms of the cavity length, to an integer multiple of half the wavelength. Using for example electrostatic or piezoelectric actuation, the spacing between the mirrors of the interferometer can be modified, as a result of which a spectrally tunable filter element can be obtained.

Fabry-Perot interferometers, which can advantageously cover as large a wavelength range as possible, should be highly reflective, inter alia, over the entire wavelength range that is to be measured. Typically, the mirrors can comprise dielectric layer systems, for example distributed Bragg reflectors (DBR), which can comprise alternating layers of high-index and low-index materials, wherein the optical thickness of these layers ideally includes a quarter of the central wavelength of the wavelength range under consideration. The following relationship gives the wavelength range AA, in which such mirrors can have a high reflectivity. The contrast of the refractive index of the high-index and low-index materials is consequently given by

$$Δ λ = λ 0 \frac{\frac{4}{π} arcsin ( \frac{{n}_{H} - {n}_{L}}{{n}_{H} + {n}_{L}} )}{1 = {( \frac{2}{π} arcsin ( \frac{{n}_{H} - {n}_{L}}{{n}_{H} + {n}_{L}} ) )}^{2}} ,$$

wherein λ0 denotes the central wavelength, n_{L} denotes the refractive index of the low-index material, and n_{H} denotes the refractive index of the high-index material.

Here, an achievable maximum reflection can, as follows, likewise be higher for the stated wavelength range for a given number of layer pairs with a higher refractive index contrast:

$$R = {( \frac{1 - {( \frac{{n}_{H}}{{n}_{L}} )}^{2 N} ( \frac{{n}_{H}^{2}}{{n}_{s u b}} )}{1 + {( \frac{{n}_{H}}{{n}_{L}} )}^{2 N} ( \frac{{n}_{H}^{2}}{{n}_{s u b}} )} )}^{2} .$$

Here, n_{SUB} equals the refractive index of the substrate if the DBR mirror is not exposed. If the DBR mirror is exposed, n_{SUB}=1. To cover the largest possible wavelength range, the refractive index of the low-index material can be as close to 1 as possible, such as in the case of gases or a vacuum. Since plane-parallelism is also important for such mirrors (layers), support structures between the mirror layers are advantageous for keeping the spacing between the individual layers within a mirror of the FPI constant (spacing between the high-index layers). Typically, parts of the upper high-index layer can be formed as support structures. The latter can extend from the upper high-index layer to the bottom one.

In U.S. Pat. No. 7,733,495 B2, a multilayer mirror and a Fabry-Perot interferometer are described. A side wall can extend between the high-index layers.

### DISCLOSURE OF THE INVENTION

The present invention provides a mirror device for an interferometer device as claimed in claim 1, an interferometer device as claimed in claim 9, and a method for producing a mirror device as claimed in claim 10.

Preferred developments are the subject of the dependent claims.

### Advantages of the Invention

The concept on which the present invention is based consists in specifying a mirror device for an interferometer device comprising improved spacing structures between mirror layers in a mirror device. The spacing structures can be used for maintaining a constant spacing between the mirror layers of a mirror device and simultaneously as spacers for the mirror device from another element, such as an electrode, a substrate, or another mirror device.

According to the invention, the mirror device for an interferometer device comprises a first mirror layer and a second mirror layer, which are arranged parallel one above the other with a mirror layer distance between them, wherein the mirror layer distance forms an intermediate space between the first and the second mirror layer, and wherein the intermediate space includes a gas or a vacuum; at least one spacing structure extending at least partially between the first and the second mirror layer, and wherein the spacing structure comprises a material that is the same as or different from the first and/or second mirror layer.

The vertical extent can be tilted perpendicular to the planar plane of extent or can be oblique, for example at an angle of 70° or 80° with respect to the planar plane of extent, that is to say deviating from a vertical direction.

The spacing structure can comprise a material that is the same as or different from the first and/or second mirror layer. In the event that the spacing structure comprises the same material as one or both mirror layers, this can still be detectable in the finished component (mirror device) because the spacing structure and the mirror layers can be producible separately from one another, that is to say not act as one overall component, and can also differ from one another. The spacing structure and the mirror layers can comprise for example silicon (poly-Si), and in each mirror layer and also in the spacing structure, new growth of the poly-Si can thus take place during their production. In the case of separately produced structures, the material structure, for example crystallinity, can be detectably different from a continuous structure made of the same material. For this reason, mirror layers and a spacing structure from the same crystalline material, which were produced separately, can be detectably different in terms of their material structure from a structure that was produced (grown) continuously in one step.

According to a preferred embodiment of the mirror device, the spacing structure comprises side walls that extend vertically from a planar direction of extent of the first and second mirror layers or extend in deviation from a vertical direction by a specific angle.

According to a preferred embodiment of the mirror device, the spacing structure projects at least into one of the two mirror layers.

According to a preferred embodiment of the mirror device, the spacing structure comprises a core between the side walls and a bottom, wherein the side walls and the bottom comprise a different material than the core.

According to a preferred embodiment of the mirror device, the side walls and the bottom comprise an electrically insulating material.

According to a preferred embodiment of the mirror device, the spacing structure projects at least through one of the two mirror layers and beyond an outer side of the first and/or second mirror layers by at least one thickness of one of the mirror layers.

According to a preferred embodiment of the mirror device, the latter comprises a plurality of spacing structures that, in a top view of a planar top side of the second mirror layer, form a hexagonal grid.

According to a preferred embodiment of the mirror device, in a region below and/or above the recess, the first and/or second mirror layer projects perpendicularly from the planar direction of extent of the first mirror layer in a direction away from the recess.

According to the invention, the interferometer device comprises a substrate; a first mirror device and a second mirror device, wherein at least one of them comprises a mirror device according to the invention, which are arranged over the substrate and one above the other, spaced apart from one another by a first spacing, wherein at least the first mirror device is arranged movably in relation to the second mirror device; and an actuating device by means of which at least the first and/or second mirror device is movable.

According to the invention, the method for producing a mirror device includes providing a first sacrificial layer and/or a substrate; applying a first mirror layer onto the first sacrificial layer and/or onto the substrate; applying a second sacrificial layer on the first mirror layer; forming a recess at least in the second sacrificial layer that extends at least up to the first mirror layer; introducing a material for a spacing structure into the recess; applying a second mirror layer onto the second sacrificial layer and over the recess; and at least partially removing the first and/or the second sacrificial layer.

The method can advantageously also be characterized by the features mentioned in connection with the mirror device and the advantages thereof, and vice versa.

According to a preferred embodiment of the method, introducing the material for a spacing structure into the recess involves arranging an electrical insulator layer in the recess and on the top side of the second sacrificial layer and then introducing the material for a core of the spacing structure into the recess such that the recess is filled.

According to a preferred embodiment of the method, the material of the recess or at least the material for the core is backthinned before the second mirror layer is applied in order to produce a planar connection with regions that laterally adjoin the recess.

Further features and advantages of embodiments of the invention are evident from the following description with respect to the attached drawings.

### BRIEF DESCRIPTION OF THE DRAWINGS

The present invention will be explained in more detail below with reference to the exemplary embodiments specified in the schematic figures of the drawing.

In the drawings:

FIGS. 1a-f show a schematic side view of the mirror device according to a plurality of exemplary embodiments of the present invention;

FIGS. 2a-f show a schematic side view of the mirror device during a method for producing the same according to one exemplary embodiment of the present invention;

FIGS. 3a-d show a schematic side view of the mirror device during partial steps of a method for producing same according to a further exemplary embodiment of the present invention;

FIG. 4 shows a schematic side view of the interferometer device according to an exemplary embodiment of the present invention; and

FIG. 5 shows a schematic block diagram of method steps of a method according to an exemplary embodiment of the present invention.

In the figures, identical reference signs denote identical or functionally identical elements.

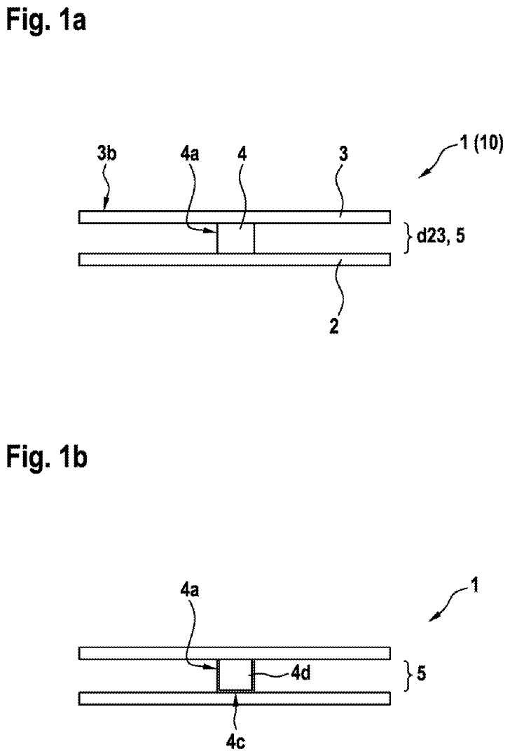

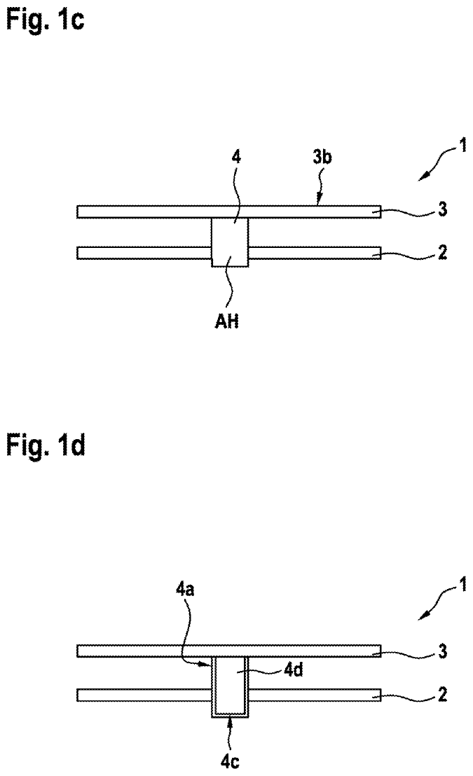

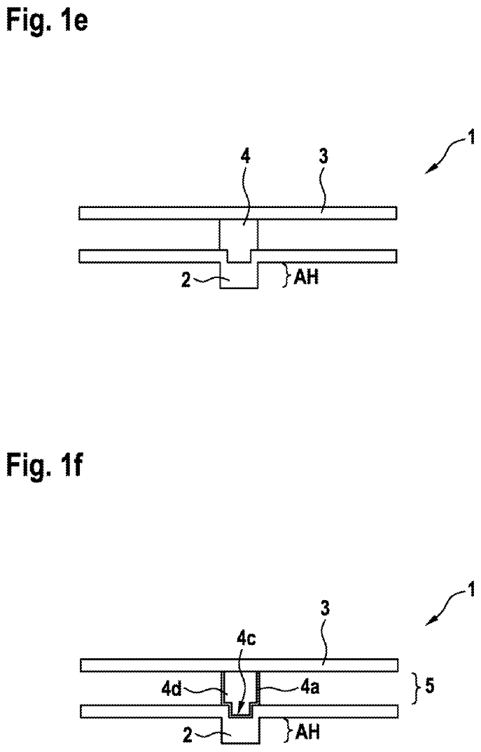

FIGS. 1a-f show schematic side views of mirror devices according to a plurality of exemplary embodiments of the present invention.

FIGS. 1a-f each show a mirror device 1 for an interferometer device 10, comprising a first mirror layer and a second mirror layer 3, which are arranged parallel one above the other with a mirror layer distance d23 between them, wherein the mirror layer distance d23 forms an intermediate space 5 between the first and the second mirror layer (2, 3), and wherein the intermediate space 5 includes a gas or a vacuum. The mirror device 1 comprises at least one spacing structure 4 between the first and the second mirror layer (2, 3), which spacing structure extends vertically from a planar direction of extent of the first and second mirror layer (2, 3) or comprises side walls 4a extending in deviation from a vertical direction by a specific angle, and wherein the spacing structure 4 comprises a material that is the same as or different from the first and/or second mirror layer (2, 3).

The spacing structures 4 shown can undergo lateral deformations, for example resulting from the inner tensile stress (mechanical) in the mirror layers. Since the spacing structures advantageously comprise a different material than the mirror layers, these can be mechanically and advantageously electrically adapted to the requirements of the spacing structure, for example in order to be able to better maintain a tensile stress that is advantageously set in the layers (due to the reduced relaxation of the spacing structures), as a result of which the optically usable surface (the planarity of the mirrors with a defined spacing) can also be increased.

Furthermore, the spacing structures can terminate substantially planar with a top side of the mirror layer, which cannot produce any elevation above the mirror layer (produces hardly any or no topography), which may be advantageous both for process control and also for the optical and mechanical properties of any further (mirror) layers that may follow (consequently, little or no bending of the following layers of a further mirror may occur). During filling of the recess, the material for the spacing structure can form a planar surface with a tolerance with a top side of the mirror layer that faces away from the first mirror layer. The tolerance for a planar termination can have a deviation of at most the thickness of the mirror layer.

In FIG. 1a, the spacing structure 4 advantageously extends only between the two mirror layers 2 and 3 (can touch them), without at the same time projecting into (the plane of extent of) these mirror layers 2 and 3 and can comprise the same material both in the side wall 4a and also in the inner region (core), advantageously also only one material. In FIGS. 1c and 1e, the spacing structure 4 can have a similar shape as in FIG. 1a, with the difference that the spacing structure 4 can additionally extend at least partially (FIG. 1e) or entirely (FIG. 1c) into or through the (plane of extent) first mirror layer 2. In the embodiment of FIG. 1c, the spacing structure 4 can form a spacer AH below the first mirror layer 2, where the spacing structure 4 can project downwardly beyond the first mirror layer 2 perpendicularly to the planar direction of extent.

Furthermore, a plurality of spacing structures 4 may also be present, which can form, in a top view of a planar top side 3b of the second mirror layer 3, a hexagonal grid or other geometric shapes (not shown).

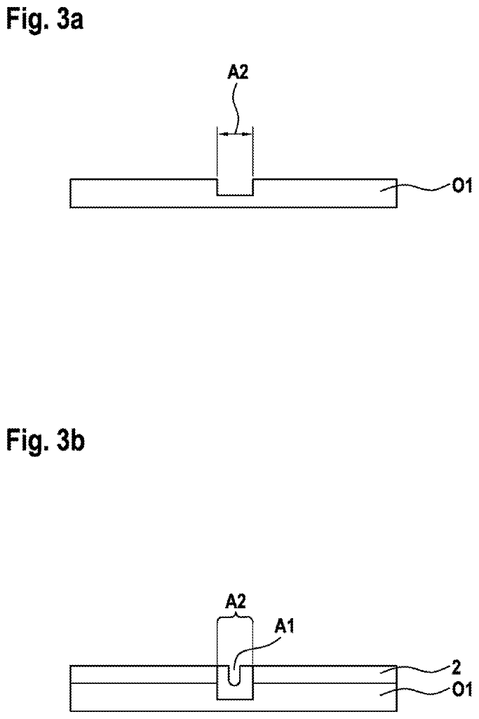

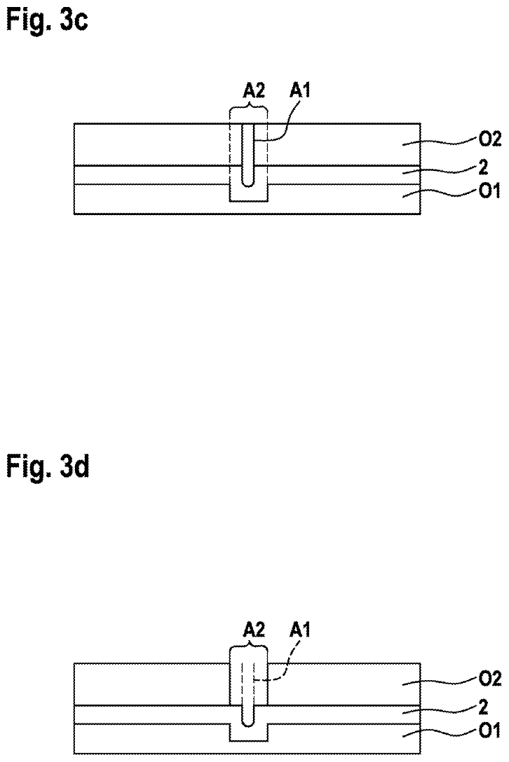

According to FIG. 1f, the spacing structure 4 can partially extend into the (plane of extent) first mirror layer 2, for example with an anchor region that can have a laterally smaller dimension than the spacing structure 4 has between the mirror layers 2 and 3. This shape can be provided according to the sequence of method steps in FIG. 3 (more specific reference is to follow in FIG. 3). The spacer below the first mirror layer 2 can accordingly comprise the material of the first mirror layer 2 with a recess in the direction of the second mirror layer 3, in which the spacing structure 4 is held and can be stabilized mechanically with respect to lateral tensile forces.

According to FIGS. 1b, 1d and 1f, the spacing structure 4 can comprise a core 4d within the side wall 4a, and a bottom 4c, wherein the bottom 4c and the side walls 4a can be produced from the same material and a core 4d can comprise a different material. The outer extents of the spacing structures 4 in FIG. 1b advantageously correspond to FIG. 1a; in FIG. 1d to that of FIG. 1c; and in figure if to that of FIG. 1e.

The spacing structure can consequently be deposited separately from the mirror layers and form a base for depositing the second mirror layer. The embodiment can also be expanded to include further mirror layers, advantageously using further mirror layers and sacrificial layers.

The gas (mixture) in the intermediate space 5, for example air, or a vacuum can represent (replace) a low-index layer and have a refractive index of approximately one. The mirror layers 2 and 3 can have, for example, silicon as the high-index material having a refractive index of, for example, 3.5. Rather than silicon, germanium or silicon carbide can also be used, or different materials that can be compatible with (resistant to) sacrificial layer etching processes. If air is used as the low-index material, it is possible to achieve a large refractive index difference with respect to the high-index material and to produce a spectrally broadband, highly reflective mirror device.

The spacing structures 4 can stabilize the mirror layers relative to one another in order to ensure, via as large an optical region (aperture area) of the mirror device as possible, a spacing of the mirrors (mirror devices) of one quarter wavelength of the central wavelength (that is to be transmitted or filtered), that is to say that the low-index layer (air) has a thickness of a quarter wavelength.

The material of the spacing structure 4 can be, for example, a semiconductor material and/or the same material as at least one of the mirror layers. The deposition process of the material of the spacing structure can be adapted to the mechanical and electrical properties (conductivity electrical, thermal, vertical electrical insulation of the mirror layers) of the mirror layers and the production process. However, these properties can also be set independently of the requirements regarding the mirror layers. For example, the doping and/or crystallinity can be variable. The spacing structure and the mirror layers can differ in their materials in terms of doping or crystallinity, but can also comprise a different semiconductor material. The spacing structure can be electrically insulating, for example the material of the core. From a mechanical standpoint, this spacing structure can be highly stable and resistant to breakage and hardly permit any deformations of the mirrors (membranes/layers), in particular their separation, for example no or little notch effect under stress.

The spacing structures can be designed as at least partially laterally continuous wall structures and/or as column structures, for example as honeycomb structures.

A predetermined separation between the mirror layers can be maintained due to reduced yielding or no yielding. The spacing structures can be embodied, in a top view, nearly in the shape of points, resulting in minimization of optical losses.

The material in the core 4d can comprise a high-index material (as compared to the intermediate region with gas, gas mixture or vacuum), similar to one of the mirror layers.

In the event of contact between the mirror layer 2 and an underlying structure, the spacers AH (anti-stiction bumps) can reduce the contact area and thus the static friction, which can prevent the mirror layer from irreversibly sticking to an underlying structure. Any overhang of the spacers beyond the mirror layer can preferably be greater than a thickness of the mirror layer (first one) itself. With particular preference, the overhang is greater than a thickness of the second sacrificial layer. The spacers AH can thus be made from an electrically insulating material or surrounded by an electrically insulating layer in order to prevent fusion in the event of contact being made with an underlying structure that is at a different electrical potential.

In a mirror device of this type, reduced deformation of the spacing structures (lateral) and of a mirror region can be attained due to continuous mirror layers that remain substantially planar.

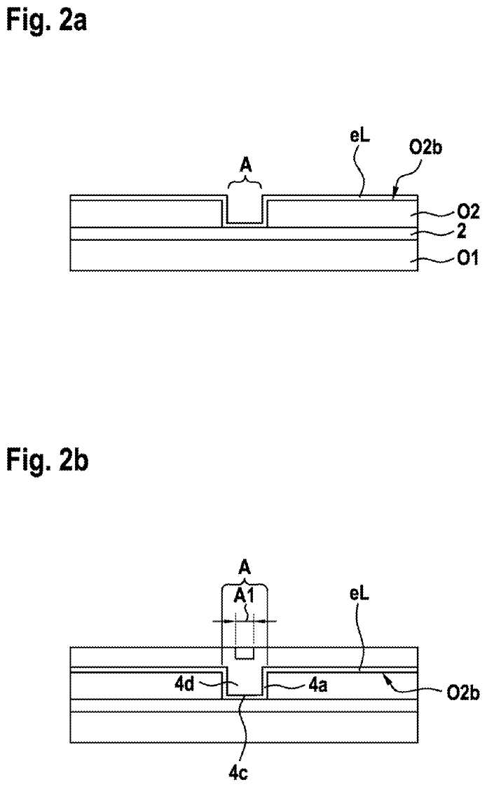

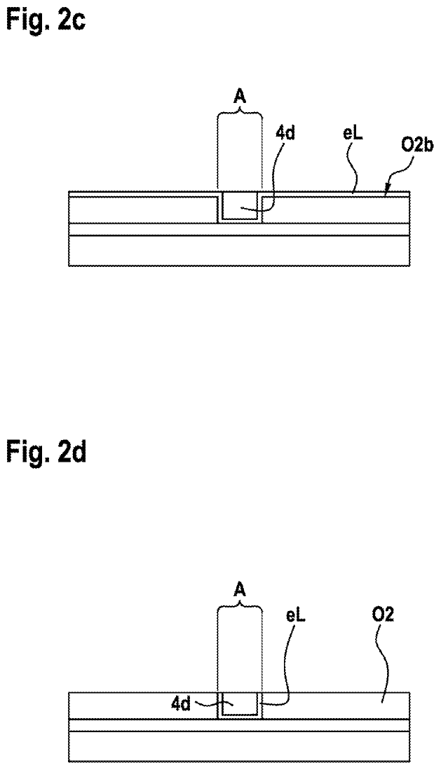

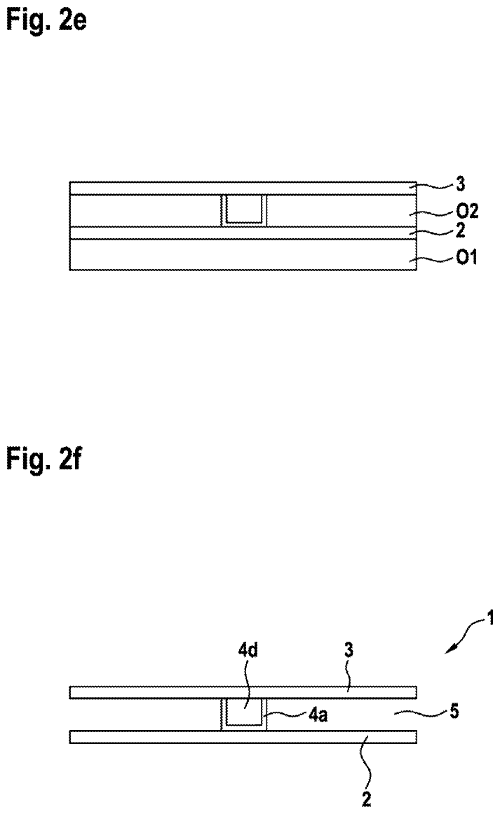

FIGS. 2a-f show a schematic side view of the mirror device during a method for producing the same according to an exemplary embodiment of the present invention.

The step of FIG. 2a involves providing (S1) a first sacrificial layer O1 or a substrate (not shown) and possibly an intermediate layer between the substrate and the first mirror layer; applying (S2) a first mirror layer 2, advantageously two-dimensionally, onto the first sacrificial layer O1; applying (S3) a second sacrificial layer O2 on the first mirror layer 2; and forming (S4) a recess A at least in the second sacrificial layer O2, which extends at least up to the first mirror layer 2, preferably so as to be in contact therewith. Furthermore, a cover layer eL for a side wall of the spacing structure can be applied onto a top side O2b of the second sacrificial layer O2 and introduced into the recess (onto the bottom and advantageously onto the second mirror layer and onto the side walls). The cover layer eL can comprise an electrically insulating material.

A further method step can involve, according to FIG. 2b, introducing (S5) a material 4d for a spacing structure into the recess A. The material 4d can be introduced into the recess A so as to conform with the surface and comprise, within the region of the recess A, a step as an inner recess A1 in the material 4d.

According to the further method, according to FIG. 2c, backthinning (polishing, etching) of the material 4d of the cover layer eL can take place, and a planar top side can thus be produced. In this case, the material 4d outside of the recess a is advantageously removed entirely, and the inner recess can disappear because of it. For removing the material 4d of the core, the cover layer eL can serve as a stop layer, or further layers that can serve as stop layer may be present.

In a further step, according to FIG. 2d, the cover layer eL, and if necessary further layers, outside the recess A can be removed, and the second sacrificial layer can advantageously be exposed toward the top. Within the region of the recess A, the material 4d and the cover layer eL can extend vertically beyond the second sacrificial layer O2 or be planarized (polishing, etching) with respect to the second sacrificial layer O2.

After the method step of FIG. 2e, a second mirror layer 3 can be applied (S6) onto the second sacrificial layer O2 and over the recess A.

In a further method, according to FIG. 2f, the first and the second sacrificial layer O1 and O2 can be at least partially removed (S7), which may result in a mirror device 1 with an intermediate space 5 between the two mirror layers 2 and 3. This embodiment advantageously corresponds to that of FIG. 1b; with different depths for the recess and by dispensing with the cover layer, it is also possible to produce in a similar manner a different exemplary embodiment from FIG. 1.

The recess A or further recesses (smaller ones) can be, in a top view of a planar direction of extent, circular, elliptical or have a different shape, such as elongated.

The elliptical shape can be characterized by better optical properties, in particular by a reduction in optical losses.

Using a third mirror layer and further sacrificial layers and corresponding recesses, the process sequences shown can be modified and multilayer mirror devices having a plurality of low-index layers and high-index layers (mirror layers) can be formed. The spacing structures can then be formed continuously between the plurality of mirror layers.

Furthermore, the first and the second sacrificial layer can be removed, for example by way of a sacrificial layer etching process using etching holes. The etching holes can be distributed (selective etching) in the first and/or second mirror layer (not shown).

FIGS. 3a-d show a schematic side view of the mirror device during partial steps of a method for producing the same according to a further exemplary embodiment of the present invention.

The partial steps can relate to the production of a mirror device as shown in FIG. 1e.

According to FIG. 3a, a recess A2 can be introduced in a first sacrificial layer O1, which may, for example, have been deposited on a carrier or substrate (not shown). According to FIG. 3b, the material of the first mirror layer 2 can then be applied onto the first sacrificial layer O1 and advantageously likewise (in a conforming manner) in the recess A2. By depositing in a conforming manner, it is then possible to form a laterally smaller recess A1 in the material of the first mirror layer within the recess A2, wherein the former can however project, depending on the layer thickness of the first mirror layer 2, to below the top side of the first sacrificial layer O1 or a top side of the first sacrificial layer can terminate above that height (from above).

According to FIG. 3c, a second sacrificial layer O2 can be applied onto the first mirror layer 2 and fill the smaller recess A1 in the first mirror layer 2.

In a further method step, according to FIG. 3d, a recess can be formed in the second sacrificial layer O2, which can extend above the recess A2 from FIG. 3a and can have an equal, smaller or greater lateral extent than the recess A2. The recess A can also be entirely shifted laterally with respect to the recess A2.

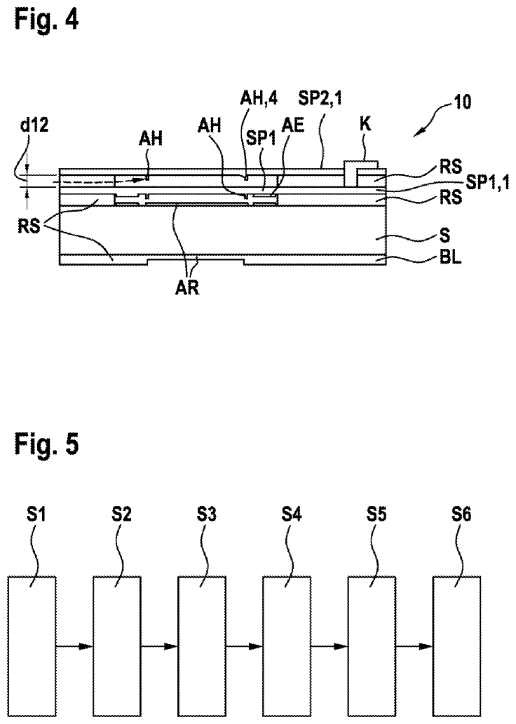

FIG. 4 shows a schematic side view of the interferometer device according to an exemplary embodiment of the present invention.

The interferometer device 10 can comprise a substrate S; a first mirror device SP1 and a second mirror device SP2, wherein at least one of these mirror devices can comprise a mirror device according to the invention, as shown in FIGS. 1 to 3. The mirror devices SP1 and SP2 are arranged over the substrate S and one above the other, spaced apart from one another by a first spacing d12, wherein at least the first mirror device SP1 is arranged movably in relation to the second mirror device SP2; and an actuating device by means of which at least the first and/or the second mirror device is movable.

The mirror devices SP1 and/or SP2 can comprise spacing structures 4 according to the invention with or without an overhanging portion, that is to say the spacers AH, toward the top or the bottom (relative to the substrate). The spacers AH can be placed on the substrate or on different elements. The interferometer device can comprise a peripheral structure RS outside an optical region, wherein the mirror devices SP1 and SP2 may be clamped in the peripheral structure RS and be contacted thereby with a contact K. In the optical region, the mirror devices can be exposed and the light path can be influenced by aperture stops BL and antireflective layers AR on the substrate S. The interferometer device can be designed as a Fabry-Perot interferometer (FPI). The FPI can be produced by depositing a plurality of sacrificial layers, wherein a sacrificial layer can be deposited on the substrate S, then the first mirror device can be formed thereon, then a further sacrificial layer can be deposited on the first mirror device, and a second mirror device can in turn be produced thereon. The thickness of the further sacrificial layer can be used for setting the first distance d12 and be set independently of the actuation gap, with the actuation gap being formed by the actuation electrodes between the substrate S and the first mirror device SP1. An FPI of this type does not need to be advantageously limited to a travel (actuation spacing or first spacing) of a third of the original optical gap (first spacing in the deflected position).

The interferometer device can be formed as a micro-electromechanical device (MEMS), for example as a micro-spectrometer.

FIG. 5 shows a schematic block diagram of method steps of a method according to an exemplary embodiment of the present invention.

The method for producing a mirror device involves providing S1 a first sacrificial layer and/or a substrate; applying S2 a first mirror layer onto the first sacrificial layer and/or onto the substrate; applying S3 a second sacrificial layer on the first mirror layer; forming S4 a recess at least in the second sacrificial layer, which extends at least up to the first mirror layer; introducing S5 a material for a spacing structure into the recess; applying S6 a second mirror layer onto the second sacrificial layer and over the recess; and at least partially removing S7 the first and the second sacrificial layer.

Even though the present invention has been described completely above with reference to the preferred exemplary embodiment, it is not limited thereto, but rather modifiable in multifarious ways.

1. A mirror device for an interferometer device comprising:
a first mirror layer and a second mirror layer, which are arranged parallel one above the other with a mirror layer distance between them, wherein the mirror layer distance forms an intermediate space between the first and the second mirror layer, and wherein the intermediate space includes a gas or a vacuum; and
at least one spacing structure extending at least partially between the first and the second mirror layer, and wherein the spacing structure comprises a material that is the same as or different from the first and/or second mirror layer.

2. The mirror device as claimed in claim 1, in which the spacing structure comprises side walls that extend vertically from a planar direction of extent of the first and second mirror layer or extend in deviation from a vertical direction by a specific angle.

3. The mirror device as claimed in claim 1, in which the spacing structure projects into at least one of the first and second mirror layers.

4. The mirror device as claimed in claim 2, in which the spacing structure comprises a core between the side walls and a bottom, wherein the side walls and the bottom comprise a different material than the core.

5. The mirror device as claimed in claim 4, in which the side walls and the bottom comprise an electrically insulating material.

6. The mirror device as claimed in claim 1, in which the spacing structure projects through at least one of the first and second mirror layers and beyond an outer side of the at least one of the first and second mirror layer by at least one thickness of one of the first and second mirror layers.

7. The mirror device as claimed in claim 1, wherein:
the at least one spacing structure is one of a plurality of spacing structures; and
the plurality of spacing structures that, in a top view of a planar top side of the second mirror layer, a hexagonal grid.

8. The mirror device as claimed in claim 1, further comprising:
at least one recess in at least one of the first and second mirror layers, wherein, in a region at least one of below and above the recess, the at least one of the first and second mirror layer projects perpendicularly from the planar direction of extent of the at least one of the first and a second mirror layer in a direction away from the recess.

9. An interferometer device comprising:
a substrate;
a first mirror device P and a second mirror device, wherein at least one of the first and second mirror devices is formed as claimed in claim 1, which are arranged over the substrate and one above the other, spaced apart from one another by a first spacing wherein at least the first mirror device is arranged movably in relation to the second mirror device; and
an actuating device configured to move at least one of the first and the second mirror device.

10. A method for producing a mirror device, comprising:
providing at least one of a first sacrificial layer and a substrate;
applying a first mirror layer onto the at least one of the first sacrificial layer and the substrate;
applying a second sacrificial layer on the first mirror layer;
forming a recess at least in the second sacrificial layer, which extends at least to the first mirror layer;
introducing a material for a spacing structure into the recess;
applying a second mirror layer onto the second sacrificial layer and over the recess; and
at least partially removing at least one of the first and the second sacrificial layer.

11. The method as claimed in claim 10, wherein introducing the material for the spacing structure into the recess comprises:
arranging an electrical insulator layer in the recess and on the top side of the second sacrificial layer; and
introducing the material into the recess such that the recess is filled thereby forming a core of the spacing structure.

12. The method as claimed in claim 11, wherein at least one of the electrical insulator layer and the core is back thinned before the second mirror layer is applied in order to produce a planar connection with regions that laterally adjoin the recess.
